(19) United States
(12) Patent Application Publication
(10) Pub. No.: US 2008/0150332 A1
(43) Pub. Date: Jun. 26, 2008

(54) Stand tube assembled device

(76) Inventor: Chao-Hu Chen, Taichung (TW)

Correspondence Address: CHAO-HU CHEN, 235 Chung - Ho, Box 8-24, Taipei, omitted

(21) Appl. No.: 11/645,343

(22) Filed: Dec. 26, 2006

(51) Int. Cl. B62J 1/00

(52) U.S. Cl. 297/214

(57) ABSTRACT

A stand tube assembled device; comprising: a seat rod portion; the seat rod portion having at least one sliding groove; the sliding groove being engaged with a front clamp portion and a rear clamp portion; each of the front clamp portion and rear clamp portion having at least one slot for receiving a stud at a lower side of a cushion. The seat rod portion has two inclined sliding grooves. Each of the front clamp portion and rear clamp portion has a left clamp unit and a right clamp unit which are installed at two sides of the seat rod portion. Each of the left clamp unit and right clamp unit has an inner clamp block and an outer clamp block; the inner clamp block is engaged to the outer clamp block so as to form the slot.

### FIELD OF THE INVENTION

The present invention relates to stand tubes, and particularly to a stand tube assembled device, wherein the slope of a cushion is adjustable by adjusting a front clamp portion and a clamp portion at two sides of a seat rod portion. The weight of the burden applied to the cushion is distributed so as to enhance the strength of the structure.

### BACKGROUND OF THE INVENTION

In the prior art bicycle, a stand tube is installed at a middle section thereof for supporting a cushion. An assembly device is used to connect the stand tube and the cushion. In one prior at a top of the stand tube is formed with an elliptical portion and inner center of the elliptical portion is formed with a round hole. A rear side of the round tube is formed with a cambered hole. The cambered hole has a penetrating hole penetrating to the outer side of the elliptical portion. A clamp seat passes through the round hole and a rear end of the clamp seat has a protruded cambered block inserts into the cambered hole. A screw screws into the screw hole to tighten the block and the seat so as to adjust the elevation of the clamping seat. However in the prior art, only one round hole and a clamping seat is used and the locking unit for adjusting the orientation has three screws, but in fact, only one screw supports the weight of the structure and thus the strength is insufficient. Furthermore, the cushion must support the weight of a human body and thus a shock will occur in driving. For a long time period, the structure will wear and destroyed, even the user hurts. As a whole, the prior art must be improved.

### SUMMARY OF THE INVENTION

Accordingly, the primary object of the present invention is to provide a stand tube assembled device, wherein the slope of the cushion is adjustable by adjusting a front clamp portion and a clamp portion at two sides of a seat rod portion. The weight of the burden applied to the cushion is distributed so as to enhance the strength of the structure.

To achieve above objects, the present invention provides a stand tube assembled device; comprising: a seat rod portion; the seat rod portion having at least one sliding groove; the sliding groove being engaged with a front clamp portion and a rear clamp portion; each of the front clamp portion and rear clamp portion having at least one slot for receiving a stud at a lower side of a cushion. By adjusting positions of the front clamp portion and the rear clamp portion, the slope of the cushion is changed. The seat rod portion has two inclined sliding grooves. Each of the front clamp portion and rear clamp portion has a left clamp unit and a right clamp unit which are installed at two sides of the seat rod portion. Each of the left clamp unit and right clamp unit has an inner clamp block and an outer clamp block; the inner clamp block is engaged to the outer clamp block so as to form the slot. The inner clamp block is installed with a guide block for guiding the outer clamp block to firmly secure to the inner clamp block.

The various objects and advantages of the present invention will be more readily understood from the following detailed description when read in conjunction with the appended drawing.

### BRIEF DESCRIPTION OF THE DRAWINGS

FIG. 1 is a schematic perspective view of the stand tube of the present invention.

FIG. 2 is an assembled schematic view of the assembly device of a stand tube of the present invention.

FIG. 3 is a lateral cross sectional view of the assembly device of a stand tube of the present invention.

FIG. 4 is a schematic cross sectional view of the assembly device of a stand tube of the present invention.

FIGS. 5 to 6 are schematic views showing the operation of the assembly device of a stand tube of the present invention.

FIGS. 7 and 8 are schematic view showing the adjustment of the elevation of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

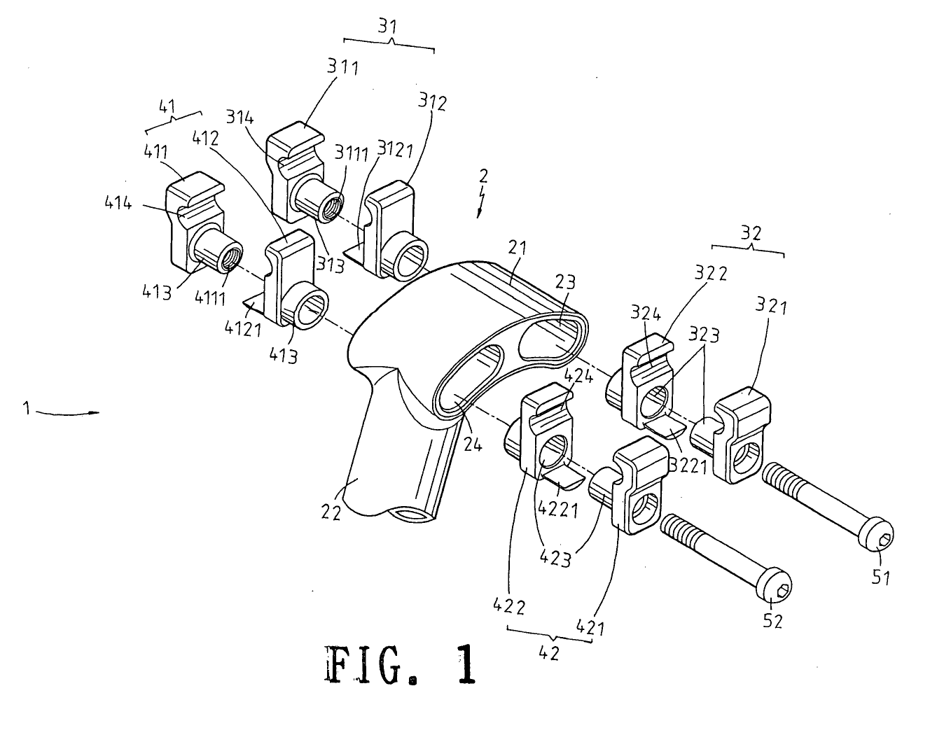

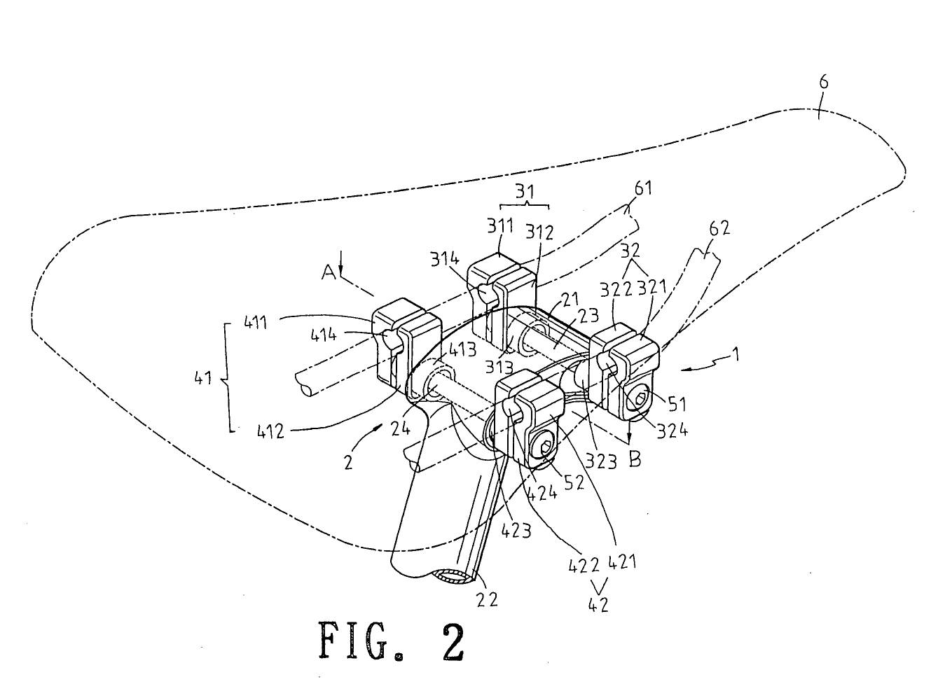

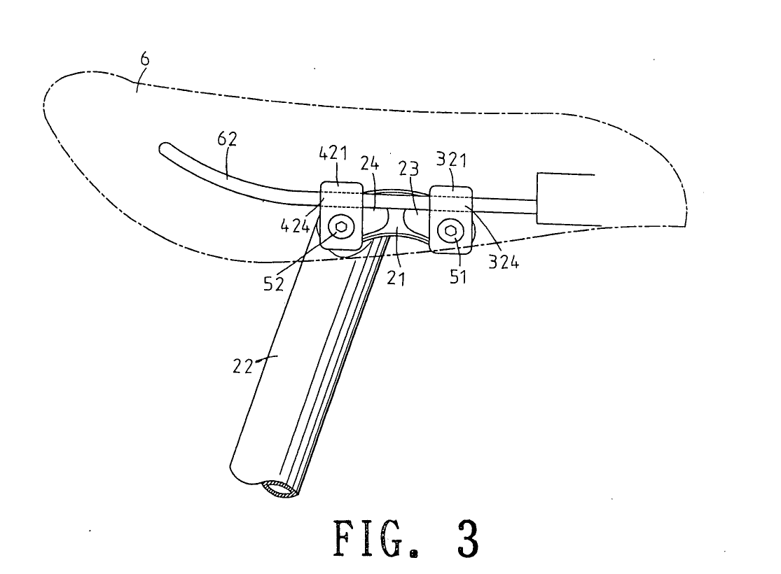

Referring to FIGS. 1 to 3, the stand tube of the present invention is illustrated. The body 1 of the present invention can be installed to a left stud 61 and a right stud 62 at a lower side of a cushion 6. The body 1 is mainly formed by a seat rod portion 2; a front clamp portion at a front end of the seat rod portion 2 and a rear clamp portion at a rear end of the seat rod portion 2. The front clamp portion and the rear clamp portion are symmetrical.

A lower end of the seat rod portion 2 has a rod body 22. An upper end of the seat rod portion 2 is a cambered head 21. A front sliding groove 23 and a rear sliding groove 24 penetrate through the head 21. The front sliding groove 23 and the rear sliding groove 24 are elliptical hole and are inclined. The front sliding groove 23 and rear sliding groove 24 are symmetrical to a central line of the head 21.

The front sliding groove 23 serves to receive the front clamp portion and the rear sliding groove 24 serves to receive the rear clamp portion. The front clamp portion has a left clamp unit 31 and the right clamp unit 32 at two sides of the front sliding groove 23. The left clamp unit 31 and the right clamp unit 32 are symmetrical at two sides of the front sliding groove 23. Each of a lower end of the left clamp unit 31 and the right clamp unit 32 has a sleeve 313, 323 respectively. Each of the left clamp unit 31 and right clamp unit 32 has an inner clamp block 312, 322 and an outer clamp block 311, 321. The outer clamp block 311, 321 is connected to the inner clamp block, 312, 322, respectively. An outer lower end of each inner clamp block 312, 322 is protruded with a positioning block 3121, 3221, respectively. By positioning block 3121, 3221, the inner clamp block 312, 322 cause that the outer clamp block 311, 321 do not rotate in connecting to the inner clamp block 312, 322. The outer clamp block 311, 321 is connected to the inner clamp block 312, 322 by using screw unit 51 so as to form with a slot 314, 324, respectively. The sleeve 313 of the left clamp unit 31 has a thread 3111. The screw unit 51 serves to screw into the slots so as to lock the left clamp unit 31 and right clamp unit 32 of the front sliding groove 23.

The structure of the rear clamp portion will be described herein. Two sides of the rear sliding groove 24 have a left clamp unit 41 and a right clamp unit 42. The front clamp portion has a left clamp unit 41 and the right clamp unit 42 at two sides of the rear sliding groove 24. The left clamp unit 41 and the right clamp unit 42 are symmetrical at two sides of the front sliding groove 23. Each of a lower end of the left clamp unit 41 and the right clamp unit 42 has a sleeve 413, 423 respectively. Each of the left clamp unit 41 and right clamp unit 42 has an inner clamp block 412, 422 and an outer clamp block 411, 421. The outer clamp block 411, 421 is connected to the inner clamp block, 412, 422, respectively. An outer lower end of each inner clamp block 412, 422 is protruded with a positioning block 4121, 4221, respectively. By positioning block 4121, 4221, the inner clamp block 412, 422 cause that the outer clamp block 411, 421 do not rotate in connecting to the inner clamp block 412, 422. The outer clamp block 411, 421 is connected to the inner clamp block 412, 422 by using screw unit 52 so as to form with a slot 414, 424, respectively. The sleeve 413 of the left clamp unit f1 has a thread 4111. The screw unit 52 serves to screw into the slots so as to lock the left clamp unit 41 and right clamp unit 42 of the front sliding groove 24.

In assembly, the left stud 61 passes through the slot 314 of the left clamp unit 31 and the slot 414 of the left clamp unit 41. The right stud 62 passes through the slot 324 of the right clamp unit 32 and the slot 424 of the right clamp unit 42.

The screw unit 51 connects the left clamp unit 31 and the right clamp unit 32 to the front sliding groove 23 and connects the left clamp unit 41 and right clamp unit 42 to the rear sliding groove 24. The inclinations of the left stud 61 and right stud 62 are determined by the positions of the front clamp portion and the rear clamp portion. The left stud 61 and right stud 62 are installed below the cushion 6. Thus the elevations of the front clamp portion and rear clamp portion determine the slope of the cushion 6.

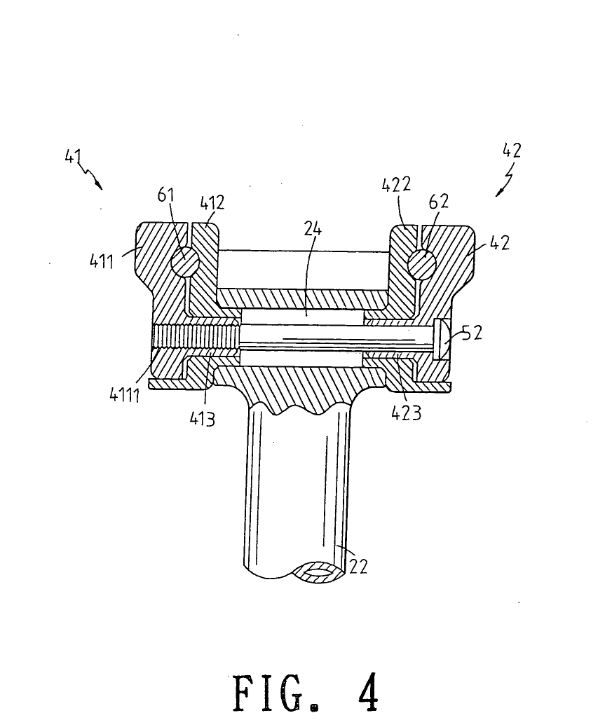

Referring to FIG. 4, a cross sectional view of the rear clamp portion is illustrated. The screw unit 52 penetrates through the right clamp unit 41, rear sliding groove 24, and left clamp unit 41 and is locked to the thread 4111 at lower side of the sleeve 413 to the lower end of the left clamp unit 41. Thus a firm structure is formed.

Therefore, it is known that by adjusting the positions of the front sliding groove 23 and rear sliding groove 24, the respect positions of the slots 314, 324, 414, 424 and the left stud 61 and right stud 62 are adjusted.

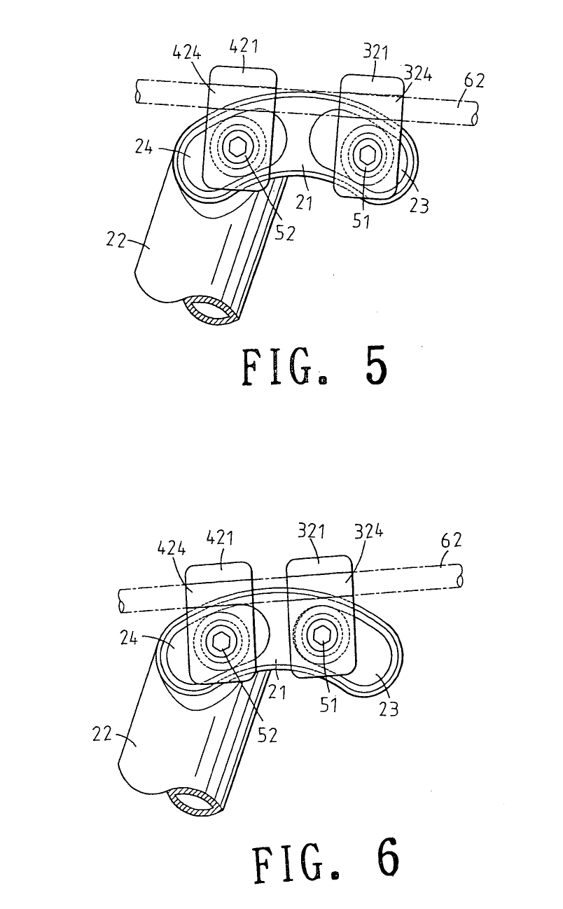

Referring to FIGS. 5 and 6, a schematic view about the operation of the present invention is illustrated. See FIG. 5, the front clamp portion is lower than the rear clamp portion, the left stud 61 and right stud 62 are inclined toward the front sliding groove 23. On the contrary, if it is desired to adjust the positions of the left stud 61 and right stud 62 to inclined toward the right stud 62, see FIG. 6, the front clamp portion is lifted and the respect positions of the slots 314, 324, 414, 424 and the left stud 61 and right stud 62 are adjusted so as to adjust the inclination of the cushion 6.

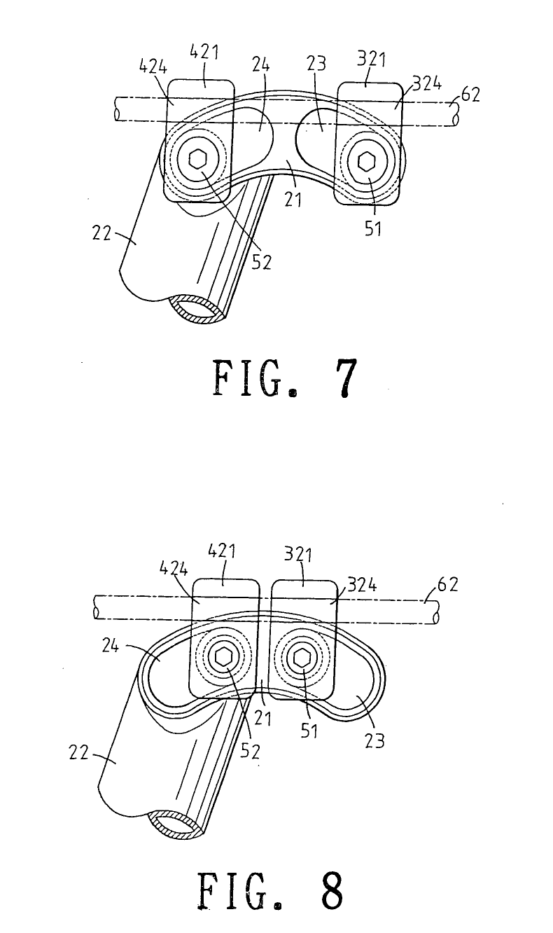

Referring to FIGS. 7 and 8, the operation of the present invention is illustrated. Before adjusting, the front clamp portion and rear clamp portion are adjusted so that the two separates from one another. Moreover, the distance between the front clamp portion and the rear clamp portion respective the left stud 61 and right stud 62 is increased, and thus the cushion 6 is lowered toward the rod body 22. Thereby if the distance is decreased, thus the distance between the left stud 61 and right stud 62 will decrease so that the cushion 6 is lifted and moves toward the head 21.

In summary, the front sliding groove 23 and rear sliding groove 24 are symmetrical along the head 21. The front clamp portion and rear clamp portion displace along the front sliding groove 23 and rear sliding groove 24. The front clamp portion and rear clamp portion will displace according to the inclination of the front sliding groove 23 and rear sliding groove 24. Thus the positions of the front clamp portion and rear clamp portion are changeable so that the slope of the cushion 6 is changed.

Furthermore, in the present invention, the front sliding groove 23 and rear sliding groove 24 can be combined as a single groove, or the rear clamp portion and front clamp portion are combined with the same slot and the front clamp portion and rear clamp portion can be secured to the slot and the left stud 61 and right stud 62 passes through the same slot; or the front sliding groove 23 and rear sliding groove 24 are symmetrical to a center of the seat rod portion 2. All these are within the scope of the present invention.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A stand tube assembled device; comprising:
a seat rod portion; the seat rod portion having at least one sliding groove; the sliding groove being engaged with a front clamp portion and a rear clamp portion; each of the front clamp portion and rear clamp portion having at least one slot for receiving a stud at a lower side of a cushion;
wherein by adjusting positions of the front clamp portion and the rear clamp portion, the slope of the cushion is changed.

2. The stand tube assembled device as claimed in claim 1, wherein the cushion is a bicycle cushion.

3. The stand tube assembled device as claimed in claim 1, wherein the seat rod portion has two inclined sliding grooves.

4. The stand tube assembled device as claimed in claim 1, wherein each of the front clamp portion and rear clamp portion has a left clamp unit and a right clamp unit which are installed at two sides of the seat rod portion.

5. The stand tube assembled device as claimed in claim 4, wherein each of the left clamp unit and right clamp unit has an inner clamp block and an outer clamp block; the inner clamp block is engaged to the outer clamp block so as to form the slot.

6. The stand tube assembled device as claimed in claim 1, wherein the inner clamp block is installed with a guide block for guiding the outer clamp block to firmly secure to the inner clamp block.
a body being mainly formed by a seat rod portion; a front clamp portion at a front end of the seat rod portion and a rear clamp portion at a rear end of the seat rod portion;
a lower end of the seat rod portion having a rod body; an upper end of the seat rod portion being a cambered head; a front sliding groove and a rear sliding groove penetrating through the head; the front sliding groove and the rear sliding groove 24 are elliptical hole and are inclined. The front sliding groove 23 and rear sliding groove 24 are symmetrical to a central line of the head 21.
The front sliding groove 23 serves to receive the front clamp portion and the rear sliding groove 24 serves to receive the rear clamp portion. The front clamp portion has a left clamp unit 31 and the right clamp unit 32 at two sides of the front sliding groove 23. The left clamp unit 31 and the right clamp unit 32 are symmetrical at two sides of the front sliding groove 23. Each of a lower end of the left clamp unit 31 and the right clamp unit 32 has a sleeve 313, 323 respectively. Each of the left clamp unit 31 and right clamp unit 32 has an inner clamp block 312, 322 and an outer clamp block 311, 321. The outer clamp block 311, 321 is connected to the inner clamp block, 312, 322, respectively. An outer lower end of each inner clamp block 312, 322 is protruded with a positioning block 3121, 3221, respectively. By positioning block 3121, 3221, the inner clamp block 312, 322 cause that the outer clamp block 311, 321 do not rotate in connecting to the inner clamp block 312, 322. The outer clamp block 311, 321 is connected to the inner clamp block 312, 322 by using screw unit 51 so as to form with a slot 314, 324, respectively. The sleeve 313 of the left clamp unit 31 has a thread 3111. The screw unit 51 serves to screw into the slots so as to lock the left clamp unit 31 and right clamp unit 32 of the front sliding groove 23.
The structure of the rear clamp portion will be described herein. Two sides of the rear sliding groove 24 have a left clamp unit 41 and a right clamp unit 42. The front clamp portion has a left clamp unit 41 and the right clamp unit 42 at two sides of the rear sliding groove 24. The left clamp unit 41 and the right clamp unit 42 are symmetrical at two sides of the front sliding groove 23. Each of a lower end of the left clamp unit 41 and the right clamp unit 42 has a sleeve 413, 423 respectively. Each of the left clamp unit 41 and right clamp unit 42 has an inner clamp block 412, 422 and an outer clamp block 411, 421. The outer clamp block 411, 421 is connected to the inner clamp block, 412, 422, respectively. An outer lower end of each inner clamp block 412, 422 is protruded with a positioning block 4121, 4221, respectively. By positioning block 4121, 4221, the inner clamp block 412, 422 cause that the outer clamp block 411, 421 do not rotate in connecting to the inner clamp block 412, 422. The outer clamp block 411,421 is connected to the inner clamp block 412, 422 by using screw unit 52 so as to form with a slot 414, 424, respectively. The sleeve 413 of the left clamp unit f1 has a thread 4111. The screw unit 52 serves to screw into the slots so as to lock the left clamp unit 41 and right clamp unit 42 of the front sliding groove 24.
In assembly, the left stud 61 passes through the slot 314 of the left clamp unit 31 and the slot 414 of the left clamp unit 41. The right stud 62 passes through the slot 324 of the right clamp unit 32 and the slot 424 of the right clamp unit 42.
The screw unit 51 serves the left clamp unit 31 and the right clamp unit 32 to the front sliding groove 23 and the left clamp unit 41 and right clamp unit 42 to the rear sliding groove 24. The inclinations of the left stud 61 and right stud 62 are determined by the positions of the front clamp portion and the rear clamp portion. The left stud 61 and right stud 62 are installed below the cushion 6. Thus the elevations of the front clamp portion and rear clamp portion determine the slope of the cushion 6.
